(19) United States
(12) Patent Application Publication
(10) Pub. No.: US 2024/0340744 A1
(43) Pub. Date: Oct. 10, 2024

(54) ENHANCED CELL (RE)SELECTION FOR LOW POWER WAKE-UP SIGNAL MODE OF OPERATION

(71) Applicant: Nokia Technologies Oy, Espoo (FI)

(72) Inventors: Brajesh SONI, Bangalore (IN); Jan Torst HVIID, Aalborg (DK); Knud KNUDSEN, Aalborg (DK); SunYoung LEE, Seoul (KR); Tanumay MANNA, Bangalore (IN); David BHATOOLAUL, Swindon (GB); Alok SETHI, Oulu (FI)

(21) Appl. No.: 18/609,929

(22) Filed: Mar. 19, 2024

(30) Foreign Application Priority Data
Apr. 6, 2023 (IN) 202341026095

(51) Int. Cl. H04W 36/30

(52) U.S. Cl. CPC H04W 36/302

(57) ABSTRACT

Systems, methods, apparatuses, and computer program products for enhanced cell (re) selection for low power wakeup signal (LP-WUS) mode of operation. A method may include receiving a low power wakeup signal from a network element. The method may also include evaluating a strength of the low power wakeup signal. The method may further include determining whether a cell selection criterion is satisfied based on a cell selection reception level value, a cell selection quality value, and the low power wakeup signal. In addition, the method may include carrying out a cell selection based on the determination of whether the cell selection criterion is satisfied.

### RELATED APPLICATION

This application claims priority to IN provisional Application No. 202341026095 filed Apr. 6, 2023, which is incorporated herein by reference in its entirety.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for enhanced cell (re) selection for low power wake-up signal (LP-WUS) mode of operation.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, fifth generation (5G) radio access technology or NR access technology, and/or 5G-Advanced. 5G wireless systems refer to the next generation (NG) of radio systems and network architecture. 5G network technology is mostly based on NR technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving a low power wakeup signal from a network element. The method may also include evaluating a strength of the low power wakeup signal. The method may further include determining whether a cell selection criterion is satisfied based on a cell selection reception level value, a cell selection quality value, and the low power wakeup signal. In addition, the method may include carrying out a cell selection based on the determination of whether the cell selection criterion is satisfied.

Other example embodiments may be directed to an apparatus. The apparatus may include at least one processor and at least one memory including computer program code. The at least one memory and computer program code may be configured to, with the at least one processor, cause the apparatus at least to receive a low power wakeup signal from a network element. The apparatus may also be caused to evaluate a strength of the low power wakeup signal. The apparatus may further be caused to determine whether a cell selection criterion is satisfied based on a cell selection reception level value, a cell selection quality value, and the low power wakeup signal. In addition, the apparatus may be caused to carry out a cell selection based on the determination of whether the cell selection criterion is satisfied.

Other example embodiments may be directed to an apparatus. The apparatus may include means for receiving a low power wakeup signal from a network element. The apparatus may also include means for evaluating a strength of the low power wakeup signal. The apparatus may further include means for determining whether a cell selection criterion is satisfied based on a cell selection reception level value, a cell selection quality value, and the low power wakeup signal. In addition, the apparatus may include means for carrying out a cell selection based on the determination of whether the cell selection criterion is satisfied.

In accordance with other example embodiments, a non-transitory computer readable medium may be encoded with instructions that may, when executed in hardware, perform a method. The method may include receiving a low power wakeup signal from a network element. The method may also include evaluating a strength of the low power wakeup signal. The method may further include determining whether a cell selection criterion is satisfied based on a cell selection reception level value, a cell selection quality value, and the low power wakeup signal. In addition, the method may include carrying out a cell selection based on the determination of whether the cell selection criterion is satisfied.

Other example embodiments may be directed to a computer program product that performs a method. The method may include receiving a low power wakeup signal from a network element. The method may also include evaluating a strength of the low power wakeup signal. The method may further include determining whether a cell selection criterion is satisfied based on a cell selection reception level value, a cell selection quality value, and the low power wakeup signal. In addition, the method may include carrying out a cell selection based on the determination of whether the cell selection criterion is satisfied.

Other example embodiments may be directed to an apparatus that may include circuitry configured to receive a low power wakeup signal from a network element. The apparatus may also include circuitry configured to evaluate a strength of the low power wakeup signal. The apparatus may further include circuitry configured to determine whether a cell selection criterion is satisfied based on a cell selection reception level value, a cell selection quality value, and the low power wakeup signal. In addition, the apparatus may include circuitry configured to carry out a cell selection based on the determination of whether the cell selection criterion is satisfied.

Certain example embodiments may be directed to a method. The method may include transmitting a low power wakeup signal to a user equipment. The method may also include transmitting a predefined threshold power level to the user equipment. The method may further include configuring the user equipment for cell selection based on the low power wakeup signal and the predefined threshold power level.

Other example embodiments may be directed to an apparatus. The apparatus may include at least one processor and at least one memory including computer program code. The at least one memory and computer program code may be configured to, with the at least one processor, cause the apparatus at least to transmit a low power wakeup signal to a user equipment. The apparatus may also be caused to transmit a predefined threshold power level to the user equipment. The apparatus may further be caused to configure the user equipment for cell selection based on the low power wakeup signal and the predefined threshold power level.

Other example embodiments may be directed to an apparatus. The apparatus may include means for transmitting a low power wakeup signal to a user equipment. The apparatus may also include means for transmitting a predefined threshold power level to the user equipment. The apparatus may further include means for configuring the user equipment for cell selection based on the low power wakeup signal and the predefined threshold power level.

In accordance with other example embodiments, a non-transitory computer readable medium may be encoded with instructions that may, when executed in hardware, perform a method. The method may include transmitting a low power wakeup signal to a user equipment. The method may also include transmitting a predefined threshold power level to the user equipment. The method may further include configuring the user equipment for cell selection based on the low power wakeup signal and the predefined threshold power level.

Other example embodiments may be directed to a computer program product that performs a method. The method may include transmitting a low power wakeup signal to a user equipment. The method may also include transmitting a predefined threshold power level to the user equipment. The method may further include configuring the user equipment for cell selection based on the low power wakeup signal and the predefined threshold power level.

Other example embodiments may be directed to an apparatus that may include circuitry configured to transmit a low power wakeup signal to a user equipment. The apparatus may also include circuitry configured to transmit a predefined threshold power level to the user equipment. The apparatus may further include circuitry configured to configure the user equipment for cell selection based on the low power wakeup signal and the predefined threshold power level.

### BRIEF DESCRIPTION OF THE DRAWINGS

For proper understanding of example embodiments, reference should be made to the accompanying drawings, wherein:

FIG. 1 illustrates example user equipment (UE) operations with a low-power wake-up receiver (WUR).

FIG. 2 illustrates an example of new radio (NR) cells with associated legacy S-criterion and LP-WUS signals.

FIG. 3 illustrates an example of enhanced NR cell (re) selection criterion, according to certain example embodiments.

FIG. 4 (a) illustrates an example WUR, according to certain example embodiments.

FIG. 4 (b) illustrates an example of Vrms, according to certain example embodiments.

FIG. 5 illustrates an example flow diagram of an enhanced cell (re) selection, according to certain example embodiments.

FIG. 6 illustrates an example flow diagram of a method, according to certain example embodiments.

FIG. 7 illustrates an example flow diagram of another method, according to certain example embodiments.

FIG. 8 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for enhanced cell (re) selection for low power wake-up signal (LP-WUS) mode of operation. For instance, certain example embodiments may be directed to enhanced cell (re) selection criterion for LP-WUS mode of operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

A user equipment (UE) may be classified as a continuous energy source. For instance, the UE may use a small rechargeable and non-rechargeable single coin cell battery, such as those used for vertical use cases (including sensors and actuators that are deployed for monitoring, measuring, and charging, etc.) Generally, such batteries are not rechargeable, and only expected to last a few years. Additionally, such devices may include wearables such as smart watches, rings, eHealth related devices, and medical monitoring devices, for which it may be challenging to sustain up to 1-2 weeks, as required, with a typical battery capacity.

Some of the UE types described above not only require a long battery life, but also require latency-critical services such as, for example, sensors for fire detection and extinguishing. Thus, solutions such as extended discontinuous reception (eDRX) (allowing to extend the periodicity by which the UE wakes up to monitor for paging, which in turn reduces the average power consumption) are not applicable since eDRX would lead to unacceptable communication latency. Thus, the technical specifications of the 3^{rd} Generation Partnership Project (3GPP) have attempted to develop ways to enable further UE power saving for the above-mentioned device types.

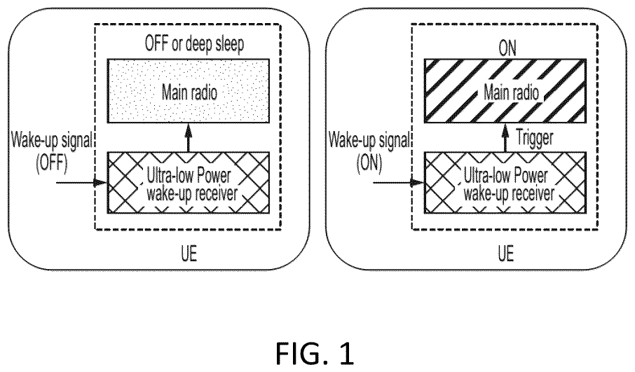

FIG. 1 illustrates example UE operations with a low-power wake-up receiver (WUR). As illustrated in FIG. 1, a network may trigger the UE to wake-up exactly when needed in an event-driven manner by transmitting a special WUS to the UE, which is monitored by a dedicated low-power WUS receiver at the UE. When the UE receives the WUS, the WUS receiver may trigger the wake-up of the ordinary NR transceiver and communication may start. Thus, the ultra-low power receiver may wake-up the main radio (MR) of the UE. Otherwise, the MR of the UE is off, or kept in a deep sleep mode. The low-power wake-up receiver may be operated in an always “on” mode, or in a duty cycled manner with very low power consumption. For example, it may be expected that the UE may consume significantly less power compared to the NR transceiver, by designing a simple (WUS) single, and using dedicated hardware for its monitoring, which is only able to receive the WUS.

The WUS may be integrated within the NR bands, and may be scheduled in parallel with NR data activity. Despite being transmitted from the same cell, varying environment conditions may have different impacts on legacy NR signal/data and the LP-WUS. Low-power radio (LR) may be a simple radio frequency receiver (RF-receiver), and may receive different degraded LP-WUS signals than the MR received legacy NR signals.

Legacy cell (re) selection criterion may take into account legacy NR signals for cell (re) selection. Since the LR may be expected to require higher signal-to-noise ratio (SNR) to decode the LP-WUS compared to the SNR required to decode a synchronization signal block (SSB), there may be a possibility that despite fulfilling the legacy S-criterion, an associated LP-WUS may not be detectable/decodable in an NR cell.

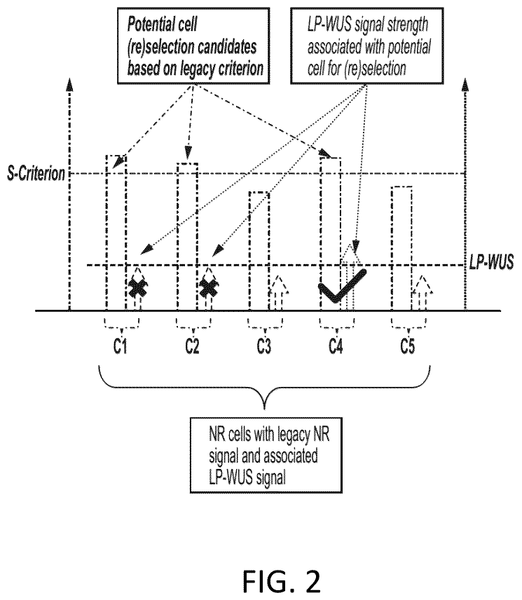

FIG. 2 illustrates an example of NR cells with associated legacy S-criterion and LP-WUS signals. In particular, FIG. 2 illustrates a legacy S-criterion 200 and associated LP-WUS signal 205 strength for cells C1, C2, C3, C4, and C5. From FIG. 2, it can be seen that cells C1, C2, and C4 match the legacy S-criterion, but have differently faded associated LP-WUS signals. Thus, cells C1 and C2 may function satisfactorily with the legacy NR, but not in LP-WUS mode of operation. Thus, in view of the above-mentioned drawbacks, certain example embodiments described herein may enhance the legacy cell (re) selection criterion to increase LP-WUS detection probability, and, thus, improve UEs working in LP-WUS mode of operation. Certain example embodiments may also relate to enhancements for UE energy savings in 5G NR, and focus on UEs/devices that have battery lifetime targets of weeks or years. Additionally, certain example embodiments may evaluate how usage of a separate low-power wake-up receiver at the UE can reduce the UE power consumption.

As described herein, the UE in certain example embodiments may consider LP-WUS signal strength while evaluating a cell (re) selection criterion. Thus, the legacy cell (re) selection criterion may be enhanced when the following is satisfied: Srxlev>0 AND Squal>0, and Wᵣₓₘₑₐₛ>W_{threshold}. Wᵣₓₘₑₐₛ may correspond to a received LP-WUS/beacon reference signal power (RSP), and W_{threshold} corresponds to an operator configurable value to ensure LP-WUS detection, and may be an offset to the LP-WUS of the S-criterion. Further, Srxlev may correspond to a cell selection reception (RX) level value (dB), and Squal may correspond to a cell selection quality value (dB). According to certain example embodiments, the LP-WUS/beacon data section may be deviated from time to time. Thus, certain example embodiments may consider only the Sync section of the signal to measure LP-WUS. The measurement of complete signal strength may also be an option to consider while evaluating the criterion.

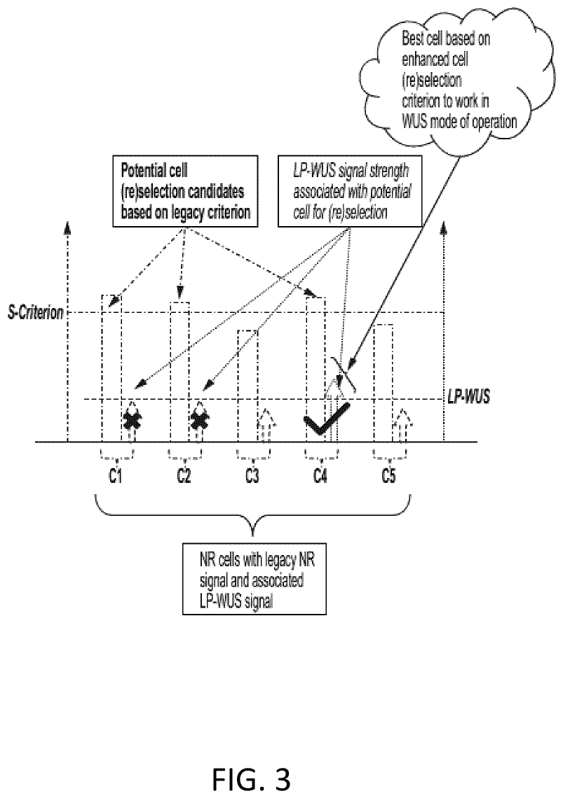

FIG. 3 illustrates an example of enhanced NR cell (re) selection criterion, according to certain example embodiments. In particular, FIG. 3 illustrates that with enhanced cell (re) selection criterion, cell C4 would be the best cell. For instance, cell C4 may ensure UEs working in LP-WUS mode of operation. Thus, the UE may be able to detect/decode a LP-WUS signal in cell C4 feasibly better than cell C1 and cell C2 in LP-WUS mode of operation. Additionally, if the UE and/or the network still wants to (re) select cell C1 or cell C2 than cell C4 due to cell preferences or other reasons, consideration of cells C1 and C2 for cell (re) selection may lie with the network and/or the UE.

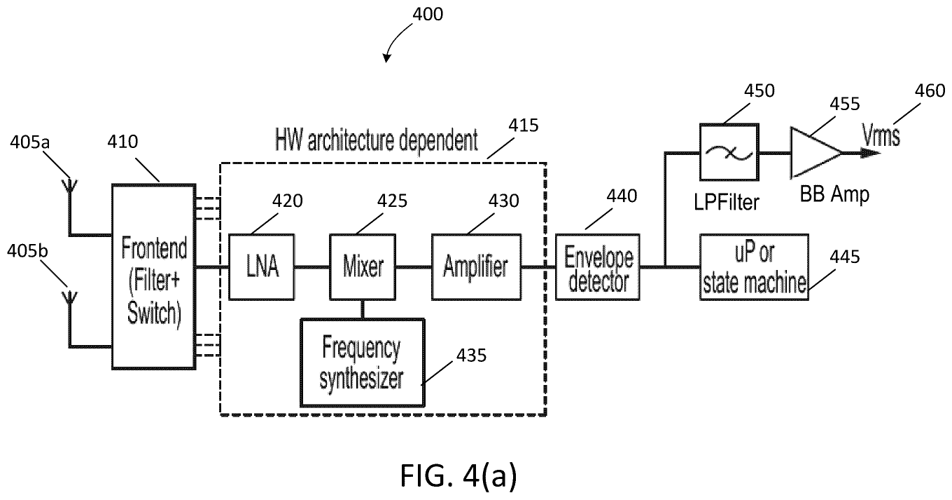

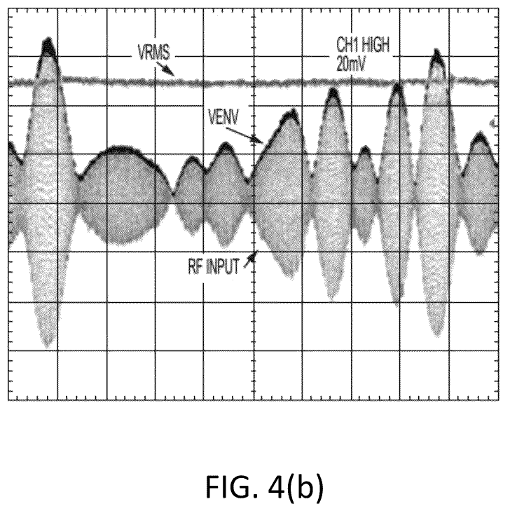

FIG. 4 (a) illustrates an example WUR 400, according to certain example embodiments. As illustrated in FIG. 4 (a), the WUR 400 includes antennas 405a, 405b, and a front-end (filter+switch) 410. The front-end 410 is connected to the hardware (HW) architecture 415, which includes a low noise amplifier (LNA) 420, mixer 425, amplifier 430, and frequency synthesizer 435. The HW architecture 415 is connected to an envelope detector 440, and the envelope detector 440 is connected to a uP or state machine 445 and LPFilter 450. Further, the WUR 400 includes a BB amp 455 connected to the LPFilter 450, and Vrms 460 may be determined from the WUR 400.

According to certain example embodiments, the LP-WUS signal may be measured. In this example, different radio frequency (RF) architecture and modulation schemes may be applicable. For example, reference signal received power/quality (RSRP/Q) measurement may not always be feasible at the LR. Since the LR receives, processes, and acts based on the LP-WUS signal, it may be desirable to evaluate the LP-WUS by the LR. An alternative to RSRP/Q may include a Vrms measurement. For instance, FIG. 4 (a) illustrates a Vrms measurement agnostic to the LR architecture. In particular, FIG. 4 (b) illustrates an example of Vrms measurement at the output of the RF-envelope detector receiver architecture, according to certain example embodiments.

Other RF receiver architectures may be considered to measure Vrms of the received LP-WUS. For instance, the LR may consider LP-WUS, low power synchronization signal (LP-SS), or LP-beacon signal to carry out the measurements. Further, the Vrms may be converted to dBm using a standard formula. Other measurements may also be considered to evaluate the received LP-WUS strength. According to certain example embodiments, the LP-WUS measurement may be used to compare the measured LP-WUS strength against a (pre) defined threshold (W-threshold).

In certain example embodiments, the network may provide a common W-threshold value to the UE through a system information block (SIB), or UE specific value to a particular UE, using dedicated signaling between the UE and the network such as cell selection criterion attribute Q-RxLevMin which is defined in TS38.304 sec 5.2.3.1. The W-threshold presence in a system information block 1 (SIB1) may indicate that the network support of the LP-WUS feature. The UE (LR) may take account of the W-RxLevMin to evaluate the received LP-WUS at the LR. W-RxLevMin may refer to the minimum required LP-WUS reception (RX) level in the cell. The W-RxLevMin may be an operator configurable parameter. Enhanced S-criteria for cell (re) selection may be considered to fulfill when a measured value of the LP-WUS is greater than the W-RxLevMin. Additionally, the MR may optionally consider W-threshold while evaluating the potential candidate cells for (re) selection considering LP-WUS mode of operation.

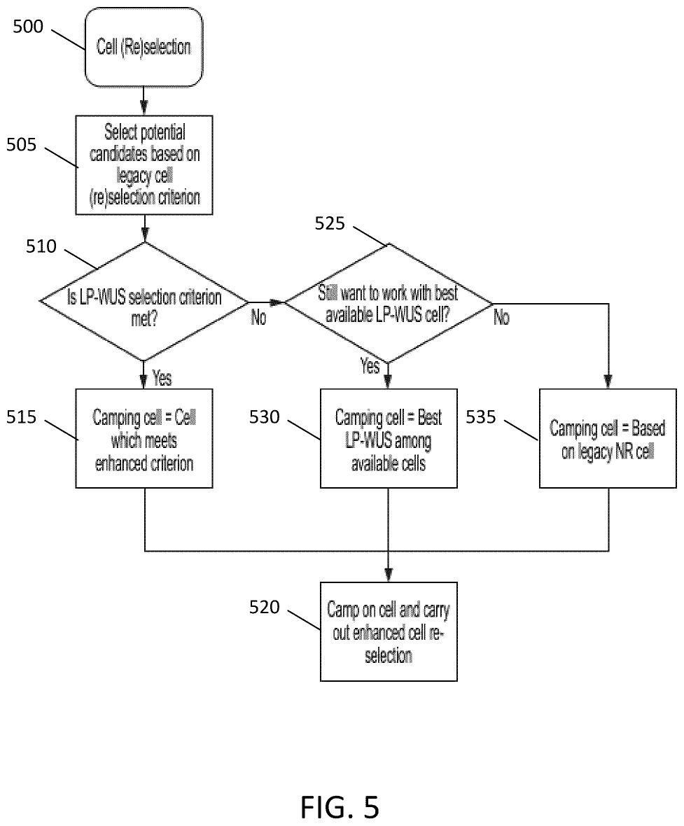

FIG. 5 illustrates an example flow diagram of the enhanced cell (re) selection, according to certain example embodiments. For instance, at 500, cell (re) selection by the UE may begin. At 505, the UE may select potential cell candidates based on the legacy cell (re) selection criterion (e.g., Srxlev>0 and Squal>0). At 510, the UE may determine whether the LP-WUS selection criterion has been satisfied. If yes, at 515, the UE may camp at the cell that meets the enhanced criterion. If no, at 525, the UE may determine whether it would still like to work with the best available LP-WUS cell. If yes, at 530, the UE may camp at the cell with the best LP-WUS among the available sets. The procedure may then proceed to 520, where the UE may camp on the cell, and carry out enhanced cell re-selection. However, if the UE determines at 525 that it no longer wants to work with the best available LP-WUS cell, the UE may camp on the cell based on the legacy NR cell.

According to certain example embodiments, the network may transmit W-RxLevMin in SIB1 and SIB2 with other legacy cell (re) selection attributes such as, for example, cellSelectionInfo and cellReselectionInfoCommon of SIB1 and SIB2, respectively, common to all UEs. In some example embodiments, the specific value of W-RxLevMin may be propagated to a UE via dedicated messages possibly DL-DCCH-MessageType::=RRCSetup or DL-DCCH-MessageType::=RRCReconfiguration. In certain example embodiments, the following information element's (IE's) (carrying legacy cell (re) selection criterion) may carry W-RxLevMin.

For instance, in certain example embodiments, the UE may obtain the LP-WUS parameter (e.g., W-RxLevMin) to evaluate the LP-WUS related to the serving cell via IE SIB1::=cellSelectionInfo { . . . }. Additionally, IE S1B1::=cellSelectionInfo may be enhanced to carry W-RxLevMin, as shown below:

```
SIB1 ::= SEQUENCE {
cellSelectionInfo SEQUENCE
  {
    ..........
    W-threshold W-RxLevMin, OPTIONAL
    ..........
  }.
```

In other example embodiments, the UE may obtain the LP-WUS parameter W-RxLevMin to evaluate the cell re-selection criterion via IE SIB2::=cellReselectionInfoCommon { . . . }. The W-RxLevMin may be present in SIB2::=cellReselectionINfoCommon may be common to all UEs in a cell. This sequence may be shown as follows:

```
SIB2 ::= SEQUENCE { cellReselectionInfoCommon SEQUENCE
      {
nrofSS-BlocksToAverage INTEGER (2..maxNrofSS-BlocksToAverage)
  OPTIONAL, -- Need S
W-threshold W-RxLevMin, OPTIONAL
            ..........
    }.
According to certain example embodiments, the specific value of W-
threshold (e.g., W-RxLevMin) may be
propagated to the UE via a dedicated
signaling message. For instance,
the following IE may be enhanced to carry
W-RxLevMin:
      MeasConfig ::= SEQUENCE
        {
          ..........
          W-threshold W-RxLevMin, OPTIONAL
          ..........
      }.
```

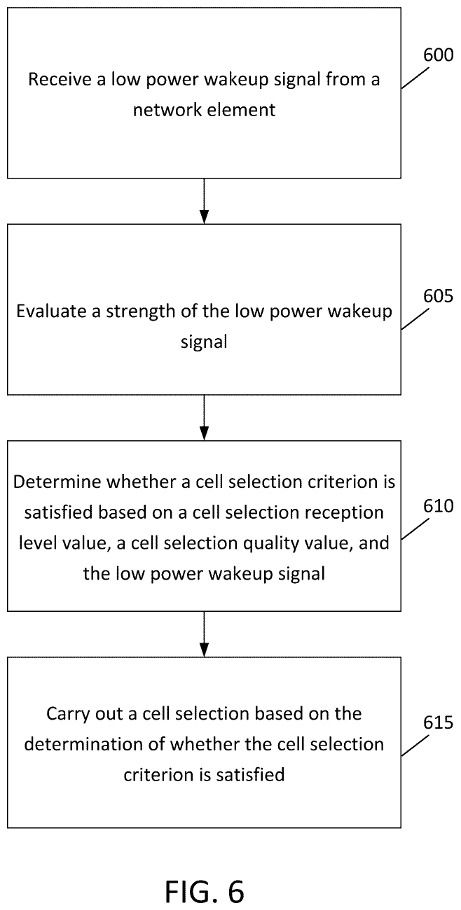

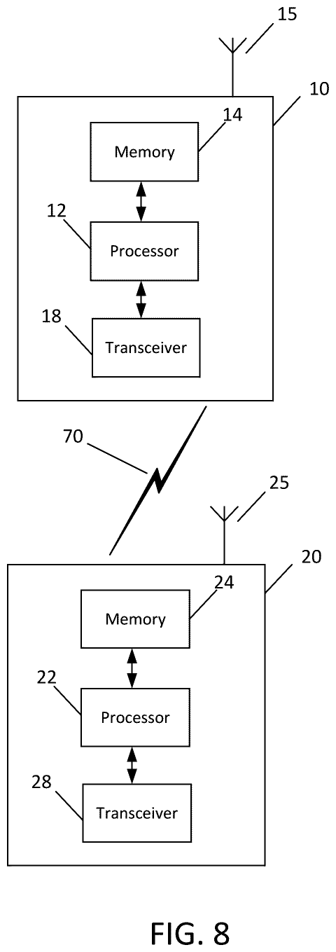

FIG. 6 illustrates an example flow diagram of a method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by a UE similar to one of apparatuses 10 or 20 illustrated in FIG. 8.

According to certain example embodiments, the method of FIG. 6 may include, at 600, receiving a low power wakeup signal from a network element. The method may also include, at 605, evaluating a strength of the low power wakeup signal. The method may further include, at 610, determining whether a cell selection criterion is satisfied based on a cell selection reception level value, a cell selection quality value, and the low power wakeup signal. In addition, the method may include, at 615, carrying out a cell selection based on the determination of whether the cell selection criterion is satisfied.

According to certain example embodiments, the evaluation may include measuring a power level of the low power wakeup signal. According to some example embodiments, the evaluation may include comparing the strength of the low power wakeup signal against a predefined threshold power level. According to further example embodiments, the predefined threshold power level may be received via a system information block 1 in a cellSelectionInfo information element. According to other example embodiments, the predefined threshold power level may be received via a system information block 2 in a cellReselectionInfoCommon information element. According to some example embodiments, the predefined threshold power level may be received via a dedicated radio resource control message in a MeasConfig information element. According to certain example embodiments, the predefined threshold power level is defined as a minimum required low power wakeup signal reception level in a cell.

In certain example embodiments, the method may further include receiving the predefined threshold power level via a system information block or a dedicated message from the network element. In some example embodiments, the cell selection criterion may be determined as satisfied when the cell selection reception level value is greater than 0, the cell selection quality value is greater than 0, and the low power wakeup signal is greater than the predefined threshold power level. In certain example embodiments, the method may further include camping on a cell that satisfies the selection criterion, or camping on a cell comprising a highest low power wakeup signal among a plurality of cells, or on a cell based on a legacy new radio cell when the selection criterion is not satisfied.

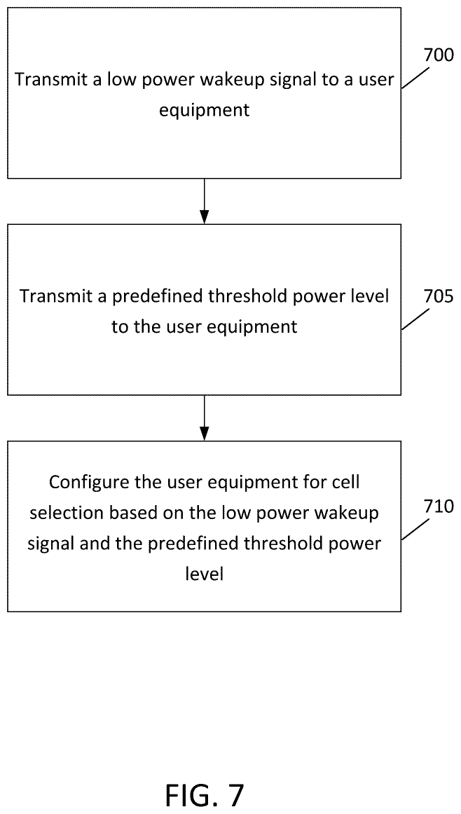

FIG. 7 illustrates an example flow diagram of another method, according to certain example embodiments. In an example embodiment, the method of FIG. 7 may be performed by a network entity, or a group of multiple network elements in a 3GPP system, such as LTE or 5G-NR. For instance, in an example embodiment, the method of FIG. 7 may be performed by a gNB similar to one of apparatuses 10 or 20 illustrated in FIG. 8.

According to certain example embodiments, the method of FIG. 7 may include, at 700, transmitting a low power wakeup signal to a UE. The method may also include, at 705, transmitting a predefined threshold power level to the UE. The method may further include, at 710, configuring the UE for cell selection based on the low power wakeup signal and the predefined threshold power level.

According to certain example embodiments, configuring the UE may include configuring the UE with a cell selection criterion. According to some example embodiments, the cell selection criterion may be determined as satisfied when a cell selection reception level value is greater than 0, a cell selection quality value is greater than 0, and the low power wakeup signal is greater than the predefined threshold power level. According to other example embodiments, the predefined threshold power level may be transmitted to the UE via a system information block or a dedicated message.

In certain example embodiments, the predefined threshold power level may be transmitted via a system information block 1 in a cellSelectionInfo information element. In some example embodiments, the predefined threshold power level may be transmitted via a system information block 2 in a cellReselectionInfoCommon information element. In other example embodiments, the predefined threshold power level many be transmitted via a dedicated radio resource control message in a MeasConfig information element. In further example embodiments, the predefined threshold power level may be defined as a minimum required low power wakeup signal reception level in a cell.

FIG. 8 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 8.

As illustrated in the example of FIG. 8, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 8, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-6.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-6.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive a low power wakeup signal from a network element. Apparatus 10 may also be controlled by memory 14 and processor 12 to evaluate a strength of the low power wakeup signal. Apparatus 10 may further be controlled by memory 14 and processor 12 to determine whether a cell selection criterion is satisfied based on a cell selection reception level value, a cell selection quality value, and the low power wakeup signal. In addition, apparatus 10 may be controlled by memory 14 and processor 12 to carry out a cell selection based on the determination of whether the cell selection criterion is satisfied.

As illustrated in the example of FIG. 8, apparatus 20 may be a network, core network element, or element in a communications network or associated with such a network, such as a gNB, BS, cell, or NW.

As illustrated in the example of FIG. 8, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1-5 and 7.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1-5 and 7.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to transmit a low power wakeup signal to a UE. Apparatus 20 may also be controlled by memory 24 and processor 22 to transmit a predefined threshold power level to the UE. Apparatus 20 may further be controlled by memory 24 and processor 22 to configure the UE for cell selection based on the low power wakeup signal and the predefined threshold power level.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving a low power wakeup signal from a network element. The apparatus may also include means for evaluating a strength of the low power wakeup signal. The apparatus may further include means for determining whether a cell selection criterion is satisfied based on a cell selection reception level value, a cell selection quality value, and the low power wakeup signal. In addition, the apparatus may include means for carrying out a cell selection based on the determination of whether the cell selection criterion is satisfied.

Additional example embodiments may be directed to an apparatus that includes means for performing any of the methods described herein including, for example, means for transmitting a low power wakeup signal to a UE. The apparatus may also include means for transmitting a predefined threshold power level to the UE. The apparatus may further include means for configuring the UE for cell selection based on the low power wakeup signal and the predefined threshold power level.

Certain example embodiments described herein provide several technical improvements, enhancements, and/or advantages. For instance, in some example embodiments, it may be possible to enhance the legacy cell (re) selection criterion to take account of LP-WUS strength with a legacy NR signal. By enhancing the legacy cell (re) selection criterion, it may be possible to increase the LP-WUS detection probability at the LR, and improve UE reachability in WUS mode of operation.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
BS Base Station
DL Downlink
eNB Enhanced Node B
E-UTRAN Evolved UTRAN
gNB 5G or Next Generation NodeB
LNA Low Noise Amplifiers
LP-SS Low Power Synchronization Signal
LR Low-Power Radio
LTE Long Term Evolution
NR New Radio
NW Network
MR Main Radio
RRC Radio Resource Control
RSRP Reference Signal Received Power
SIB System Information Block
SSB Synchronization Signal Block
UE User Equipment
UL Uplink
WUS Wake-up Signal

We claim:

1. An apparatus, comprising:
at least one processor; and
at least one memory comprising computer program code,
the at least one memory and the computer program code configured to, with storing instructions that, when executed by the at least one processor, cause the apparatus at least to:
receive a low power wakeup signal from a network element;
evaluate a strength of the low power wakeup signal;
determine whether a cell selection criterion is satisfied based on a cell selection reception level value, a cell selection quality value, and the strength of the low power wakeup signal; and
carry out a cell selection based on the determination of whether the cell selection criterion is satisfied.

2. The apparatus according to claim 1, wherein the cell selection criterion is determined as satisfied when:
the cell selection reception level value is greater than 0,
the cell selection quality value is greater than 0, and
the strength of the low power wakeup signal is greater than a predefined threshold power level.

3. The apparatus according to claim 1, wherein the evaluation of the strength of the low power wakeup signal comprises:
measuring a power level of the low power wakeup signal.

4. The apparatus according to claim 1, wherein the evaluation of the strength of the low power wakeup signal comprises comparing the strength of the low power wakeup signal against a predefined threshold power level.

5. The apparatus according to claim 4, wherein the predefined threshold power level is received via at least one of:
a system information block 1 in a cellSelectionInfo information element;
a system information block 2 in a cellReselectionInfoCommon information element; or
a dedicated radio resource control message in a MeasConfig information element.

6. The apparatus according to claim 4, wherein the predefined threshold power level is defined as a minimum required low power wakeup signal reception level in a cell.

7. The apparatus according to claim 4, wherein the apparatus is further caused to:
receive the predefined threshold power level via a system information block or a dedicated message from the network element.

8. The apparatus according to claim 1, wherein the apparatus is further caused to:
camp on a cell that satisfies the selection criterion, or
camp on a cell comprising a highest low power wakeup signal among a plurality of cells, or on a cell based on a legacy new radio cell when the selection criterion is not satisfied.

9. A method, comprising:
receiving a low power wakeup signal from a network element;
evaluating a strength of the low power wakeup signal;
determining whether a cell selection criterion is satisfied based on a cell selection reception level value, a cell selection quality value, and the strength of the low power wakeup signal; and
carrying out a cell selection based on the determination of whether the cell selection criterion is satisfied.

10. The method according to claim 9, wherein the cell selection criterion is determined as satisfied when:
the cell selection reception level value is greater than 0,
the cell selection quality value is greater than 0, and
the strength of the low power wakeup signal is greater than a predefined threshold power level.

11. The method according to claim 9, wherein the evaluation of the strength of the low power wakeup signal comprises:
measuring a power level of the low power wakeup signal.

12. The method according to claim 9, wherein the evaluation of the strength of the low power wakeup signal comprises comparing the strength of the low power wakeup signal against a predefined threshold power level.

13. The method according to claim 12, wherein the predefined threshold power level is received via at least on of:
a system information block 1 in a cellSelectionInfo information element;
a system information block 2 in a cellReselectionInfoCommon information element; or
a dedicated radio resource control message in a MeasConfig information element.

14. The method according to claim 12, wherein the predefined threshold power level is defined as a minimum required low power wakeup signal reception level in a cell.

15. The method according to claim 12, further comprising:
receiving the predefined threshold power level via a system information block or a dedicated message from the network element.

16. The method according to claim 9, further comprising:
camping on a cell that satisfies the selection criterion, or
camping on a cell comprising a highest low power wakeup signal among a plurality of cells, or on a cell based on a legacy new radio cell when the selection criterion is not satisfied.

17. An apparatus, comprising:
at least one processor; and
at least one memory comprising computer program code,
the at least one memory and the computer program code configured to, with storing instructions that, when executed by the at least one processor, cause the apparatus at least to:
transmit a low power wakeup signal to a user equipment;
transmit a predefined threshold power level associated with the low power wakeup signal to the user equipment, wherein the low power wakeup signal and the predefined threshold power level configures the user equipment for cell selection.

18. The apparatus according to claim 17, wherein configuring the user equipment comprises configuring the user equipment with a cell selection criterion.

19. The apparatus according to claim 18, wherein the cell selection criterion is determined as satisfied when:
a cell selection reception level value is greater than 0,
a cell selection quality value being is than 0, and
a strength of the low power wakeup signal is greater than a predefined threshold power level.

20. The apparatus according to claim 19, wherein the predefined threshold power level is transmitted to the user equipment via a system information block or a dedicated message.
